(19) United States
(12) Patent Application Publication
(10) Pub. No.: US 2014/0256244 A1
(43) Pub. Date: Sep. 11, 2014

(54) AIR CONDITIONING DEVICE FOR VEHICLE

(71) Applicant: TOYOTA JIDOSHA KABUSHIKI KAISHA, Toyota-shi (JP)

(72) Inventors: Hideyuki Sakurai, Toyota-shi (JP); Takao Sato, Nisshin-shi (JP)

(73) Assignee: TOYOTA JIDOSHA KABUSHIKI KAISHA, Toyota-shi (JP)

(21) Appl. No.: 14/351,983

(22) PCT Filed: Jun. 17, 2013
(86) PCT No.: PCT/JP2013/067581

§ 371 Date: Apr. 15, 2014

(30) Foreign Application Priority Data
Jul. 17, 2012 (JP) 2012-158918

(51) Int. Cl. B60H 1/24

(52) U.S. Cl. CPC B60H 1/245; B60H 1/247
USPC 454/140; 454/141

(57) ABSTRACT

An air conditioning device for a vehicle, comprising an intake portion that is provided at a cabin side at a vehicle ceiling portion, and that takes-in air; a blow-out portion that is provided at the cabin side at the vehicle ceiling portion, and that blows out, into the cabin, air that has been taken-in from the intake portion; and a blower device that is provided at the vehicle ceiling portion and that, by operating, blows air from the intake portion toward the blow-out portion, the blower device being disposed at a vehicle front-rear direction rear side of a bulging portion that bulges toward the cabin side and that accommodates a sunroof that opens and closes a roof opening portion that is formed in the vehicle ceiling portion.

### FIELD OF THE INVENTION

The present invention relates to an air conditioning device used in a vehicle that has a sunroof.

### DESCRIPTION OF THE RELATED ART

There is conventionally known a blower that, by utilizing the Coanda effect, blows air that exceeds an amount of air that is blown out from a nozzle, as shown in Japanese Patent Application Laid-Open No. 2010-077969.

### SUMMARY OF THE INVENTION

### Technical Subject

In a vehicle that has a sunroof, an accommodating portion for accommodating the sunroof must be provided and therefore, a roof head lining bulges toward a cabin side. Therefore, when attempting to mount an air conditioning device for a vehicle to a bottom surface of the roof head lining, there is the possibility that the cabin space may be reduced further.

In consideration of the above-described circumstances, the present invention provides an air conditioning device for a vehicle that can suppress a reduction in space at a cabin.

### Solution Addressing to the Subject

An air conditioning device for a vehicle of a first aspect of the present invention comprises: an intake portion that is provided at a cabin side at a vehicle ceiling portion, and that takes-in air; a blow-out portion that is provided at the cabin side at the vehicle ceiling portion, and that blows out, into the cabin, air that has been taken-in from the intake portion; and a blower device that is provided at the vehicle ceiling portion and that, by operating, blows air from the intake portion toward the blow-out portion, the blower device being disposed at a vehicle front-rear direction rear side of a bulging portion that bulges toward the cabin side and that accommodates a sunroof that opens and closes a roof opening portion that is formed in the vehicle ceiling portion.

In the air conditioning device of the first aspect, the intake portion, that takes-in air, and the blow-out portion, that blows out toward the cabin the air that has been taken-in from the intake portion, are provided at the cabin side at the vehicle ceiling portion. Further, the blower device is provided at the vehicle ceiling portion, and, due to the blower device operating, air is blown from the intake portion toward the blow-out portion.

Here, the bulging portion, that is for accommodating the sunroof that opens and closes the roof opening portion, is provided at the vehicle ceiling portion, and this bulging portion bulges toward the cabin side. The blower device is disposed at the vehicle front-rear direction rear side of this bulging portion.

Because the bulging portion bulges toward the cabin side, the surface of the vehicle ceiling portion at which the bulging portion is not provided is positioned further upper side in a vehicle vertical direction than the bottom surface of the bulging portion. By placing the blower device at the vehicle front-rear direction rear side of the bulging portion and not placing the blower device at the bulging portion, the amount of bulging of the bulging portion into the cabin, that is due to placement of the blower device, can be reduced.

In an air conditioning device for a vehicle of a second aspect of the present invention, in the air conditioning device for a vehicle of the first aspect, the blower device is provided at a step portion that is provided between the bulging portion, that is provided at a roof head lining that structures a portion of the vehicle ceiling portion, and a reference surface of the roof head lining, that is positioned further toward a vehicle vertical direction upper side than the bottom surface of the bulging portion.

In the air conditioning device for a vehicle of the second aspect, at the roof head lining that structures a portion of the vehicle ceiling portion, given that a surface at which the bulging portion is not provided is a reference surface, the bulging portion bulges toward the cabin side from this reference surface. Therefore, the step portion is provided between the bottom surface of the bulging portion and the reference surface, and the blower device is provided at this step portion. Due thereto, the amount of bulging of the bulging portion into the cabin, that is due to placement of the blower device, can be reduced.

In an air conditioning device for a vehicle of a third aspect of the present invention, in the air conditioning device for a vehicle of the first or second aspect, the intake portion is disposed at a vehicle front-rear direction rear side with respect to the blow-out portion.

In general, the position of the blow-out portion is determined in accordance with the position of the seat. Therefore, even if the blower device is disposed at the step portion that is provided between the reference surface and the bottom surface of the bulging portion, if the intake portion is disposed at the vehicle front-rear direction front side of the blow-out portion, and both the intake portion and the blow-out portion are provided further forward than the blower device, there are cases in which it is necessary to cause the airflow to move reciprocally along the vehicle front-rear direction. Accordingly, there also arise cases in which ducts, that are for causing this airflow to move reciprocally, are arrayed in the vehicle vertical direction. Therefore, in the air conditioning device for a vehicle of the third aspect, by placing the intake portion at the vehicle front-rear direction rear side of the blow-out portion, the airflow can be made to flow in one direction along the vehicle front-rear direction.

In an air conditioning device for a vehicle of a fourth aspect of the present invention, in the air conditioning device for a vehicle of the first or second aspect, the intake portion is disposed at a vehicle front-rear direction front side with respect to the blow-out portion.

Generally, a register is provided at an instrument panel that structures the vehicle front portion of the cabin, and air, whose temperature has been adjusted by an air conditioning device, is blown out from this register. Therefore, in the air conditioning device for a vehicle of the fourth aspect, by placing the intake portion at the vehicle front-rear direction front side of the blow-out portion, the air, that has been blown out from the register, is taken-in from the intake portion.

In an air conditioning device for a vehicle of a fifth aspect of the present invention, in the air conditioning device for a vehicle of the first through fourth aspects, the blow-out portion is provided along a vehicle transverse direction, and is structured to have: a first blow-out port that is positioned at a vehicle front-rear direction front portion and is provided along the vehicle transverse direction; and a second blow-out port that is provided at a vehicle front-rear direction rear portion with respect to the first blow-out port.

As described above, in an air conditioning device for a vehicle that is provided at the vehicle ceiling portion, there are cases in which the air conditioning device is provided so as to blow air toward the passengers who are seated in the second row and third row seats. Therefore, in the air conditioning device of the fifth aspect, the blow-out portion is provided along the vehicle transverse direction and is structured to include the first blow-out port and the second blow-out port, and the first blow-out port and the second blow-out port are provided together in the vehicle front-rear direction. By utilizing the airflows that are blown out from the first blow-out port and the second blow-out port, air can be blown toward the passengers who are seated in the second row seat and the third row seat.

In an air conditioning device for a vehicle of a sixth aspect of the present invention, in the air conditioning device for a vehicle of the fifth aspect, air, that has been blown out from the first blow-out port, is set so as to flow along a surface of the blow-out portion toward a second blow-out port side.

In the air conditioning device for a vehicle of the sixth aspect, the air that has been blown out from the first blow-out port is set so as to flow along the surface of the blow-out portion toward the second blow-out port side. Due thereto, the so-called Coanda effect can be utilized in the process of this air flowing along the surface of the blow-out portion. Due thereto, air at the surroundings is drawn-in by the drawing-in phenomenon (the Coanda effect), and an amount of flow that is blown by the air conditioning device can be increased.

In an air conditioning device for a vehicle of a seventh aspect of the present invention, in the air conditioning device for a vehicle of the sixth aspect, the second blow-out port is set so as to blow out air toward the cabin, such that the air from the second blow-out port intersects the air that has been blown out from the first blow-out port.

In the air conditioning device for a vehicle of the seventh aspect, due to the air, that has been blown out from the second blow-out port, intersecting (merging) with the air that has been blown out from the first blow-out port, a direction of the air that has been blown out from the first blow-out port is changed. Therefore, it suffices to not separately provide a register or the like for carrying out adjustment of the air direction.

As described above, the air conditioning device for a vehicle of the first aspect has the excellent effect that a reduction in space in the cabin can be suppressed.

The air conditioning device for a vehicle of the second aspect has the excellent effect that the amount of bulging of the bulging portion into the cabin, that arises due to placement of the blower device, can be reduced.

The air conditioning device for a vehicle of the third aspect has the excellent effect that, as compared with a case in which the intake portion is disposed at the vehicle front-rear direction front side of the blow-out portion, the amount of bulging of the bulging portion toward the cabin side at the roof head lining can be reduced.

The air conditioning device for a vehicle of the fourth aspect has the excellent effect that the air within the cabin can be adjusted efficiently.

The air conditioning device for a vehicle of the fifth aspect has the excellent effect that air can be blown respectively toward the passengers who are seated in the second row and third row seats.

The air conditioning device for a vehicle of the sixth aspect has the excellent effect that the amount of flow that is blown can be increased by utilizing the Coanda effect.

The air conditioning device for a vehicle of the seventh aspect has the excellent effect that the air direction of the air that has been blown out from the first blow-out port can be changed due to merging with the air that has been blown out from the second blow-out port.

### BRIEF DESCRIPTION OF THE DRAWINGS

FIG. 1 is an enlarged sectional view in which an air conditioning device for a vehicle and a ceiling portion of a vehicle in FIG. 2 are enlarged;

FIG. 2 is a cross-sectional view when viewing, from a side of a vehicle, the vehicle to which the air conditioning device for a vehicle of a present embodiment is applied;

FIG. 3 is a perspective view when viewing the air conditioning device for a vehicle of the present embodiment from a vehicle lower side;

FIG. 4 is a plan view when viewing the air conditioning device for a vehicle of the present embodiment from the vehicle lower side;

FIG. 5 is an enlarged sectional view showing the air conditioning device for a vehicle and the ceiling portion of the vehicle, that are cut along line 5-5 of FIG. 4;

FIG. 6 is an enlarged sectional view showing the air conditioning device for a vehicle and the ceiling portion of the vehicle, that are cut along line 6-6 of FIG. 4;

FIG. 7 is an enlarged sectional view that corresponds to FIG. 1 and shows modified example (1) of the air conditioning device for a vehicle of the present embodiment;

FIG. 8 is a perspective view that corresponds to FIG. 3 and shows modified example (1) of the air conditioning device for a vehicle of the present embodiment;

FIG. 9 is a plan view that corresponds to FIG. 4 and shows modified example (1) of the air conditioning device for a vehicle of the present embodiment;

FIG. 10 is a perspective view when viewing, from the diagonally upward and front side, a fan cover of modified example (1) of the air conditioning device for a vehicle of the present embodiment;

FIG. 11 is an enlarged sectional view cut along line 11-11 of FIG. 10;

FIG. 12 is a perspective view that corresponds to FIG. 3 and shows modified example (2) of the air conditioning device for a vehicle of the present embodiment;

FIG. 13 is a perspective view that corresponds to FIG. 3 and shows modified example (3) of the air conditioning device for a vehicle of the present embodiment; and

FIG. 14 is a perspective view that corresponds to FIG. 3 and shows modified example (4) of the air conditioning device for a vehicle of the present embodiment.

### DETAILED DESCRIPTION OF THE INVENTION

An air conditioning device for a vehicle relating to an embodiment of the present invention is described hereinafter by using the drawings. Note that, in the following explanation, when description is given by using the front, rear, left, right, up and down directions, they refer to the front, rear, left, right, up and down directions as viewed from a passenger seated in a vehicle seat. Further, arrow FR shown appropriately in the respective drawings indicates the forward direction, arrow UP indicates the upward direction, arrow RH indicates the rightward direction, and arrow LH indicates the leftward direction, respectively.

(Structure of Air Conditioning Device for Vehicle)

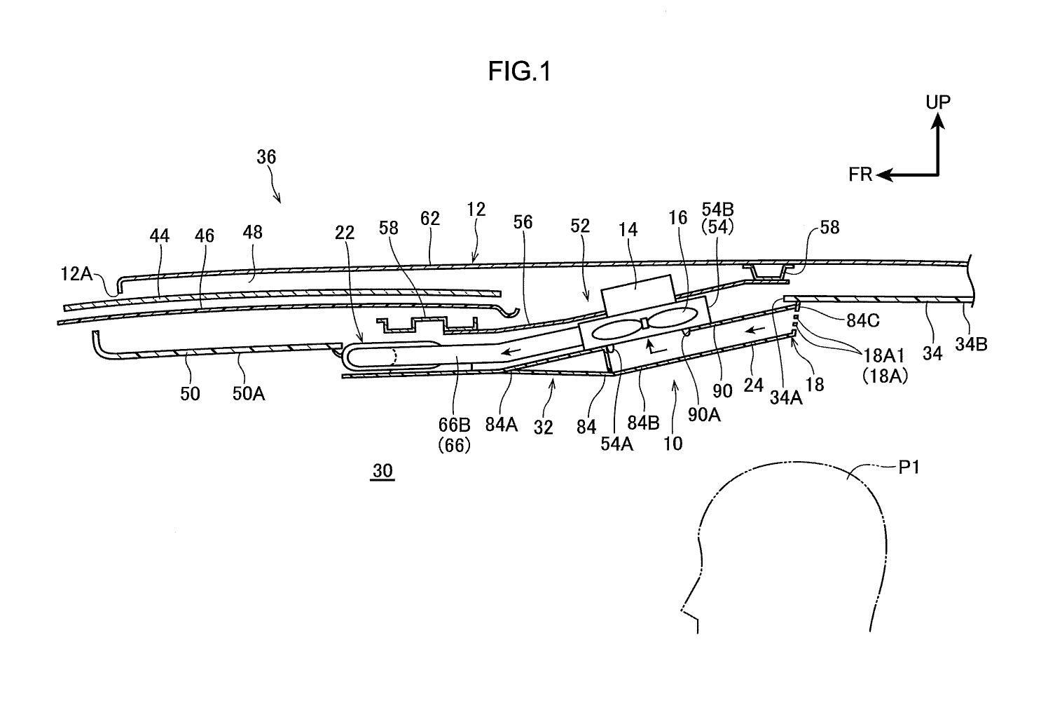

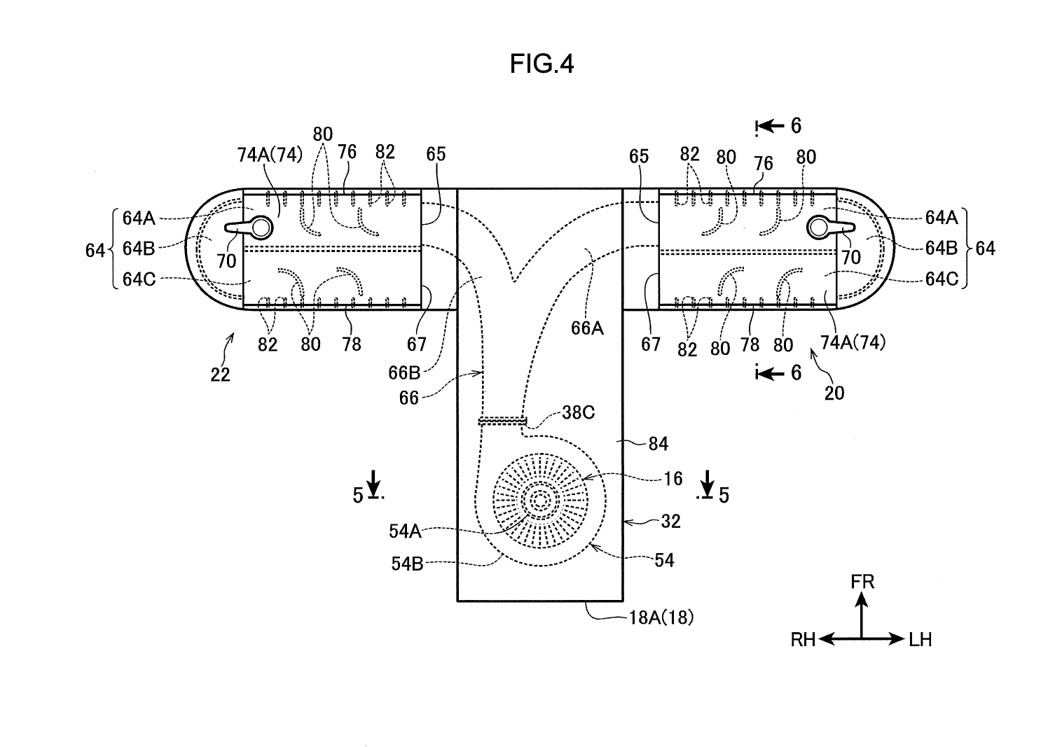

As shown in FIG. 1, an air conditioning device 10 for a vehicle of the present embodiment is disposed at a vehicle ceiling portion (hereinafter simply called “ceiling portion”) 12. This air conditioning device 10 for a vehicle is structured to include, for example, a motor 14 and a fan 16 that serve as a blower device. The fan 16 rotates and generates airflow due to operation of the motor 14. Further, other than this blower device, the air conditioning device 10 is structured to include an intake portion 18 into which air is taken-in due to rotation of the fan 16, and blow-out portions 20, 22 (refer to FIG. 4 for the blow-out portion 20) from which air is blown out due to rotation of the fan 16.

The intake portion 18 has a duct 24. An intake port 18A is provided at one end portion (one end portion along the flowing direction of the air) of the duct 24, and air within a cabin 30 is taken-in from this intake port 18A. On the other hand, as shown in FIG. 4, the blow-out portions 20, 22 are disposed symmetrically to the left and right with the fan 16 at the center, and further toward a front side than this fan 16.

The fan 16 and the blow-out portions 20, 22 are connected via ducts 66A, 66B, respectively. Therefore, air, that has been taken-in from the intake port 18A due to rotation of the fan 16, passes through the ducts 66A, 66B, and is blown out from the blow-out portions 20, 22 respectively toward a cabin 30 (see FIG. 1) side.

Further, as shown in FIG. 1, a fan cover 32, that covers the fan 16 and structures a portion of the intake portion 18, is provided at the air conditioning device 10. An opening portion 34A that is T-shaped is formed in a roof head lining 34 that structures the ceiling portion 12 of the cabin 30. The fan cover 32 and the blow-out portions 20, 22 are exposed toward the cabin 30 side via this opening portion 34A.

Hereinafter, the cabin 30 of a vehicle 36 that is provided with the air conditioning device 10 of the present embodiment, is described first, and then, the fan 16, the blow-out portions 20, 22 and the fan cover 32 will be described in that order.

(Cabin 30)

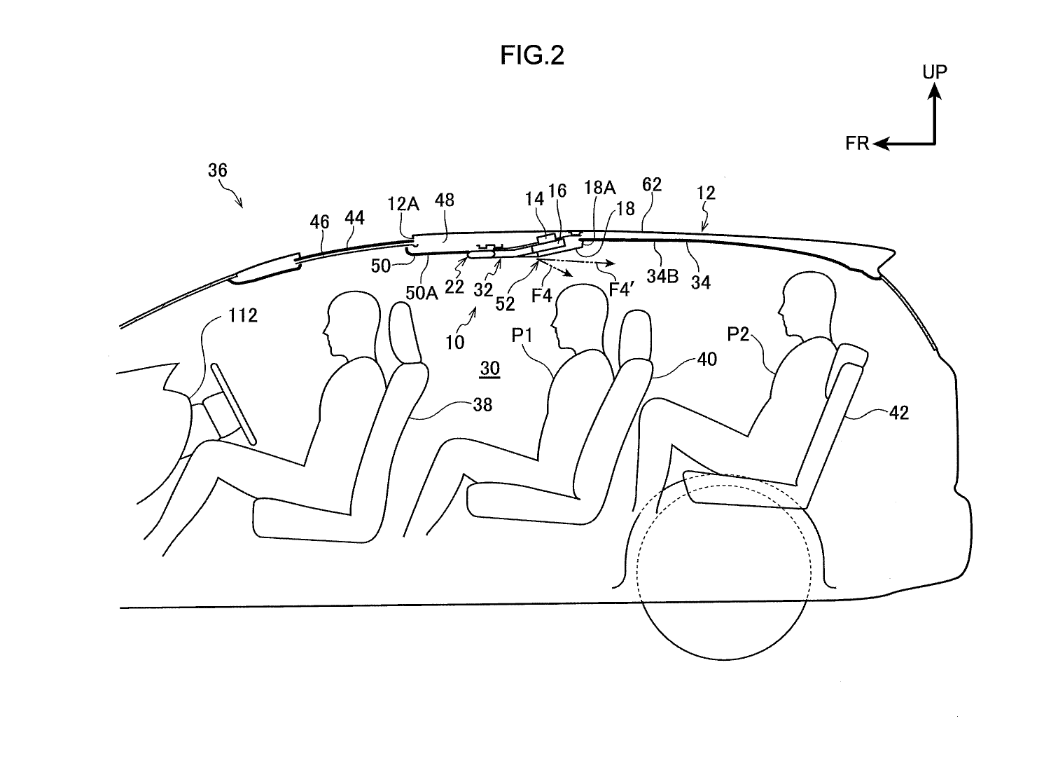

As shown in FIG. 2, the vehicle 36 that is provided with the air conditioning device 10 for a vehicle of the present embodiment is a one-box vehicle with three rows of seats. Seats 38, 40, 42 are provided respectively in the order of the first row, the second row, the third row in the cabin 30 of the vehicle 36. The seats 30 of the first row are the driver's seat and the front passenger's seat. The seat 40 of the second row and the seat 42 of the third row are respectively, for example, bench type seats on which three passengers can sit.

Further, a roof opening portion 12A is provided at an upper side of the first row seats 38. This roof opening portion 12A can be opened and closed by a sunroof 44 and a shade 46.

Moreover, an accommodating portion 48, in which the sunroof 44 and the shade 46 are accommodated, is provided at an upper side of an area between the first row seats 38 and the second row seat 40. This accommodating portion 48 protrudes (bulges) toward the cabin 30 side, and, accompanying this, a bulging portion 50 is provided at the roof head lining 34 that structures a portion of the ceiling portion 12 of the cabin 30.

(Fan 16)

As shown in FIG. 4, the fan 16 is a sirocco fan that has numerous blades at a radial direction outer side and that blows out, toward the radial direction outer side, air that has been sucked into an axially central portion. As shown in FIG. 1 and FIG. 4, this fan 16 is fixed to a shaft of the motor 14 whose axial direction is along a vehicle vertical direction. Further, the fan 16 is disposed at a vehicle transverse central portion and at a rear side of the bulging portion 50, that is provided at the roof head lining 34 at the ceiling portion 12 of the cabin 30.

Namely, as shown in FIG. 2, the fan 16 is disposed at a rear side of the first row seats 38 and at a front side of the second row seat 40 and at the central portion in the vehicle transverse direction. Here, as shown in FIG. 1, a stepped portion 52 is provided between a rear side of a bottom surface 50A of the bulging portion 50, and a reference surface 34B of the roof head lining 34 at which the bulging portion 50 is not provided. This step portion 52 is inclined toward the upper side while heading toward the rear side, and the motor 14 and the fan 16 are disposed at this step portion 52.

As shown in FIG. 1 and FIG. 4, the fan 16 is covered by a shroud 54 that has a circular opening portion 54A at a lower side, and has a peripheral wall portion 54B at a radial direction outer side of the fan 16. Further, this fan 16, motor 14 and shroud 54 are fixed via a bracket 56 to a roof reinforcement 58 that structures a portion of the ceiling portion 12 of the vehicle 36.

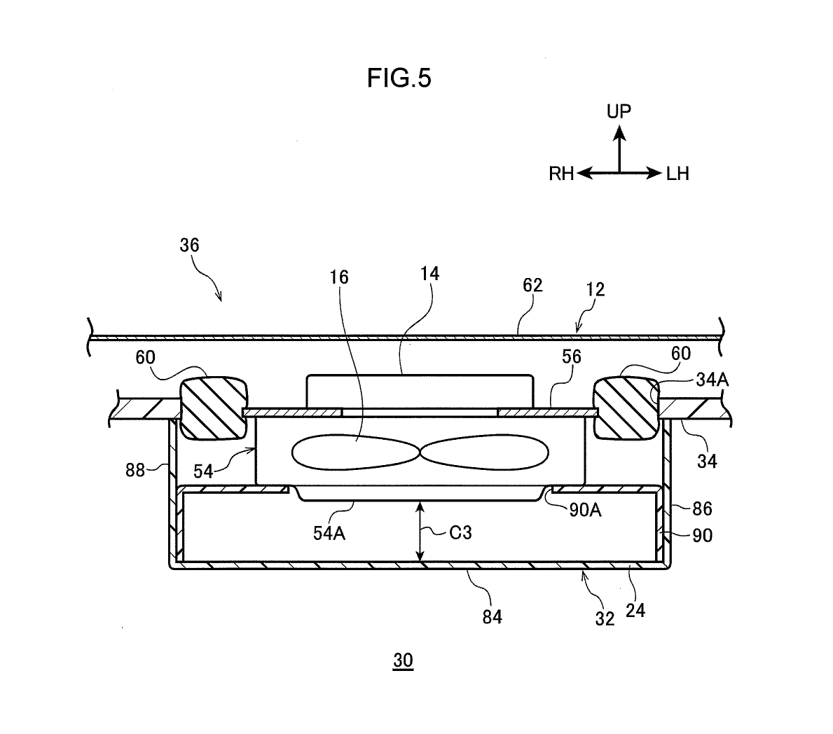

As shown in FIG. 5, a sealing material 60 is provided around the bracket 56, and a gap between the bracket 56 and the opening portion 34A that is formed in the roof head lining 34 is filled-in. Due thereto, air (air that is cooled or warmed by external air or sunlight or the like) between the roof head lining 34 and a roof panel 62, that structure the ceiling portion 12 of the vehicle 36, is not sucked into the fan 16.

(Blow-Out Portion 22)

Here, before the blow-out portions 20, 22 that are shown in FIG. 4 are described, first, the first duct portion 66A and the second duct portion 66B, that are connected to the blow-out portions 20, 22 respectively, are described. As described above, the fan 16 is covered by the shroud 54, and a flange portion 38C is provided at the shroud 54. A base portion of a Y-shaped duct 66, that is structured so as to include the first duct portion 66A and the second duct portion 66B that branch-off toward the left and the right in the vehicle transverse direction, is connected to this flange portion 38C. The first duct portion 66A curves toward the vehicle transverse direction left side and is connected to the blow-out portion 20, and the second duct portion 66B curves toward the vehicle transverse direction right side and is connected to the blow-out portion 22. Note that, because the structure of the blow-out portion 20 is substantially the same as the structure of the blow-out portion 22, here, the structure of the blow-out portion 22 is described, and description of the blow-out portion 20 is omitted.

The blow-out portion 22 has a flow path 64 that is substantially U-shaped and that opens toward the vehicle transverse direction inner side. This flow path 64 is structured to include a first flow path 64A that extends toward a vehicle transverse direction outer side, a second flow path 64B that is bent back in a substantial U shape from a vehicle transverse direction outer side end portion of the first flow path 64A toward the vehicle rear side, and a third flow path 64C that extends toward a vehicle transverse direction inner side via the second flow path 64B.

The second duct portion 66B is connected to an end portion 65 at a vehicle transverse direction inner side of the first flow path 64A that is positioned at a starting end portion of the flow path 64, and airflow from the fan 16 is introduced-in. Further, an end portion 67 at a vehicle transverse direction inner side of the third flow path 64C that is positioned at a final end portion of the flow path 64 is a closed end. Moreover, a damper 70, that adjusts an amount of flow of the airflow that flows-in from the first flow path 64A via the second flow path 64B into the third flow path 64C, is provided at this blow-out portion 22.

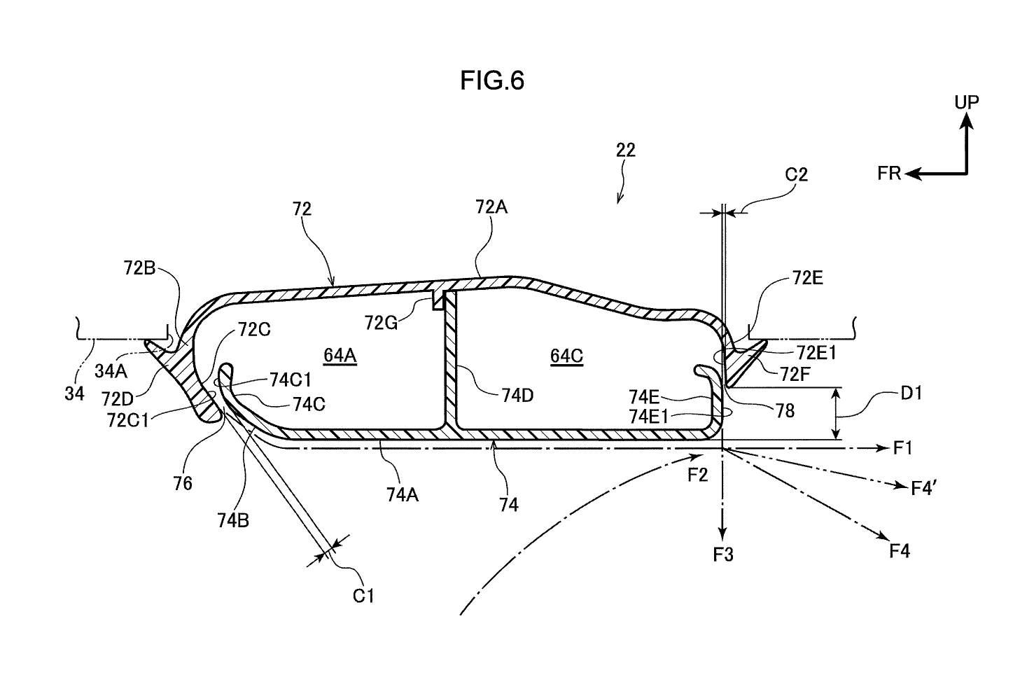

The structure of the blow-out portion 22 is described in further detail. As shown in FIG. 6, the blow-out portion 22 is a structure that is divided in two vertically. Namely, the blow-out portion 22 is formed by an upper structural body 72 and a lower structural body 74, both of which are formed of a resin material. The upper structural body 72 opens toward the lower side and the lower structural body 74 opens toward the upper side, and the upper structural body 72 is disposed so as to cover the lower structural body 74.

An upper wall portion 72A, that extends in the vehicle front-rear direction and the vehicle transverse direction, is provided at the upper structural body 72 that structures the upper portion of the blow-out portion 22. A front wall portion 72B, that is bent toward the lower side, is provided at a front end portion of the upper wall portion 72A. An inclined wall portion 72C extends from a lower end portion of the front wall portion 72B so as to be inclined toward the rear side. An abutting piece 72D, that is bent toward the front side and the upper side, extends from a lower end portion of this inclined wall portion 72C, and can abut a peripheral edge portion of the opening portion 34A that is formed in the roof head lining 34.

Further, a rear wall portion 72E, that is bent toward the lower side, is provided at a rear end portion of the upper wall portion 72A. An abutment piece 72F, that is bent toward the rear side and the upper side, extends from a lower end portion of this rear wall portion 72E, and can abut a peripheral edge portion of the opening portion 34A. Moreover, a rib 72G, that projects toward the lower side and extends in the vehicle transverse direction, is provided at a central portion in the vehicle front-rear direction of the upper wall portion 72A.

A lower wall portion 74A, that extends in the vehicle front-rear direction and the vehicle transverse direction, is provided at the lower structural body 74 that structures the lower portion of the blow-out portion 22. A front wall portion 74B, that is bent toward the upper side, is provided at a front end portion of the lower wall portion 74A. An inclined wall portion 74C extends from a front end portion of the front wall portion 74B. The inclined wall portion 74C is bent toward the upper side and faces the inclined wall portion 72C of the upper structural body 72 in the vehicle front-rear direction such that an overlapping portion is formed together with the inclined wall portion 72C. A predetermined distance C1 is provided between a front wall surface 74C1 at the front side of the inclined wall portion 74C and a rear wall surface 72C1 at the rear side of the inclined wall portion 72C (details are described later).

Further, a rear wall portion 74E extends from a rear end portion of the lower wall portion 74A. The rear wall portion 74E is bent toward the upper side and faces the rear wall portion 72E of the upper structural body 72 in the vehicle front-rear direction. A predetermined distance C2 is provided between a rear wall surface 74E1 at the rear side of the rear wall portion 74E and a front wall surface 72E1 at the front side of the rear wall portion 72E (details are described later). Moreover, a separating wall portion 74D, that projects toward the upper side and whose distal end portion extends along the rib 72G of the upper structural body 72, is provided at a central portion in the vehicle front-rear direction of the lower wall portion 74A. Further, as shown in FIG. 4, guide ribs 80, 82 are provided at the lower wall portion 74A of the lower structural body 74. The guide ribs 80, 82 are for guiding the air that has flowed into the blow-out portion 22, toward a blow-out port 76 for main flow and a blow-out port 78 for an air direction adjusting flow.

The first flow path 64A is formed by the upper wall portion 72A, the front wall portion 72B and the inclined wall portion 72C of the above-described upper structural body 72, and the partitioning wall portion 74D, the lower wall portion 74A, the front wall portion 74B and the inclined wall portion 74C of the lower structural body 74. Further, the third flow path 64C is formed by the upper wall portion 72A and the rear wall portion 72E of the upper structural body 72, and the partitioning wall portion 74D, the lower wall portion 74A and the rear wall portion 74E of the lower structural body 74. Moreover, the second flow path 64B (see FIG. 4) is formed by the upper wall portion 72A of the upper structural body 72, and the lower wall portion 74A of the lower structural body 74, and the like.

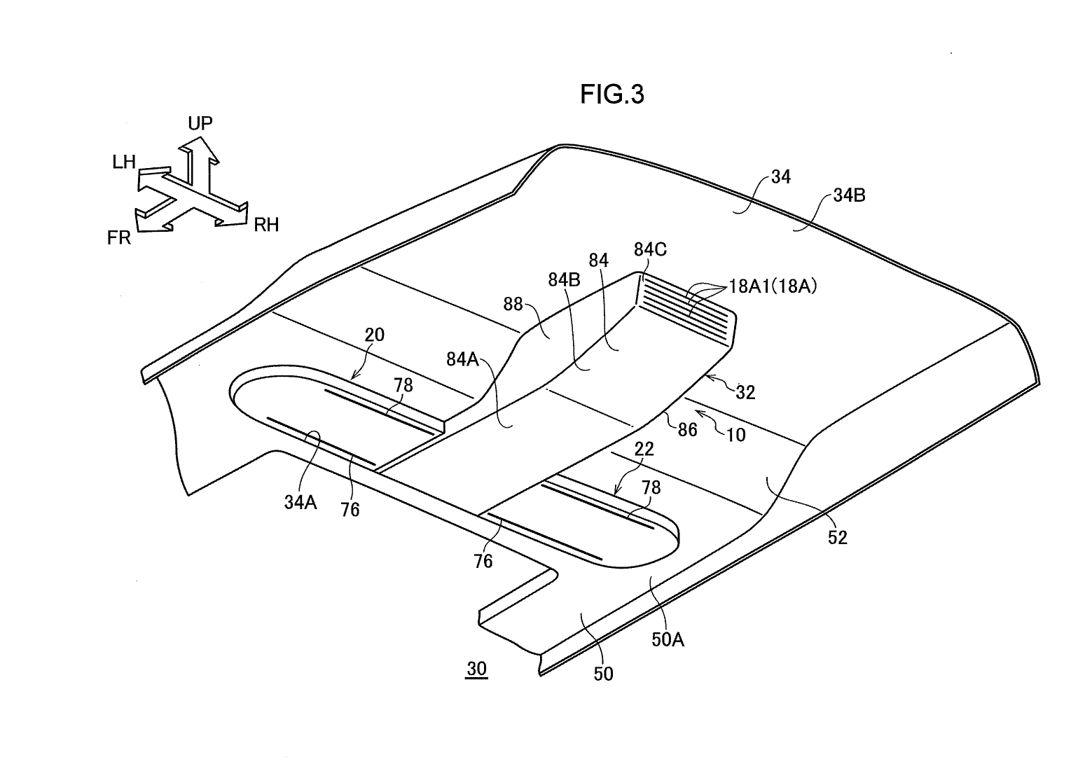

Here, at the blow-out portion 22, as described above, the predetermined distance C1 is provided between the rear wall surface 72C1 of the inclined wall portion 72C at the upper structural body 72, and the front wall surface 74C1 of the inclined wall portion 74C at the lower structural body 74. Due thereto, the blow-out port 76 for main flow that serves as a first blow-out port is formed. This blow-out port 76 for main flow is formed in a shape of a long hole that opens toward a diagonally rear side of the vehicle and whose longitudinal direction is along the vehicle transverse direction (see FIG. 3).

Further, the predetermined distance C2 is provided between the front wall surface 72E1 of the rear wall portion 72E at the upper structural body 72, and the rear wall surface 74E1 of the rear wall portion 74E at the lower structural body 74. Due thereto, the blow-out port 78 for air direction adjusting flow that serves as a second blow-out port is formed. This blow-out port 78 for air direction adjusting flow is formed in a shape of a long hole that opens toward the lower side and whose longitudinal direction is along the vehicle transverse direction (see FIG. 3).

In this way, at the blow-out portion 22, as shown in FIG. 4, the blow-out port 76 for main flow and the blow-out port 78 for air direction adjusting flow are disposed so as to oppose one another in the vehicle front-rear direction. Concretely, the blow-out port 76 is provided at a front portion at the blow-out portion 22, and the blow-out port 78 is provided at a rear portion at the blow-out portion 22. Further, the air, that has flowed into the blow-out portion 22 from the fan 16 via the duct 66B, is blown out from the blow-out port 76 for main flow and the blow-out port 78 for air direction adjusting flow.

Moreover, in the present embodiment, as shown in FIG. 6, airflow F1 that is blown out from the blow-out port 76 flows along a surface of the lower wall portion 74A of the lower structural body 74, and is set so as to intersect airflow F3 that is blown out toward the lower side from the blow-out port 78.

Further, the blow-out port 78 is disposed at the upper side, by a distance D1, in the vehicle vertical direction from the lower wall portion 74A, and it is ensured that the flow of the airflow F3 is blown out toward the lower side from the blow-out port 78. Moreover, due to the blow-out port 78 being disposed so as to be apart, toward the upper side and by the distance D1, from the lower wall portion 74A of the lower structural body 74, the generation of a vortex due to the airflow F3 merging with the airflow F1 that is blown out from the blow-out port 76 is suppressed.

(Fan Cover 32)

As shown in FIG. 1 and FIG. 3, the fan cover 32 has a bottom wall 84 that extends in the vehicle front-rear direction and the left-right direction, and a right-side wall 86 and a left-side wall 88 that are bent and extend toward the upper side from the both left and right end portions of the bottom wall 84 respectively. As seen from a side surface that runs along the vehicle front-rear direction, the bottom wall 84 is formed, from the front end portion to the central portion, as a horizontal portion 84A that is provided substantially horizontally.

Further, from the vehicle front-rear direction central portion to the rear end portion of the bottom wall 84 is made so as to be an inclined portion 84B that is inclined upward while heading toward the rear side, in conformance with the shape of the step portion 52 that is provided at the roof head lining 34. A vertical wall portion 84C, that is formed along the vertical direction toward a roof head lining 34 side, is provided at the rear end portion of the bottom wall 84. The duct 66, the fan 16, the shroud 54, and the like are covered by this fan cover 32.

Here, the fan cover 32 structures a portion of the duct 24. The intake port 18A, that is structured by plural rectangular holes 18A1 that are formed along the vehicle transverse direction and into which air is taken-in due to rotation of the fan 16, is formed in the vertical wall portion 84C of the fan cover 32.

Further, as shown in FIG. 5, a duct member 90, that opens toward the lower side and that is formed in an inverted U shape in cross section as seen from the vehicle front, is provided at a lower portion of the fan cover 32. Due to this duct member 90 being fit-together with the lower portion of the fan cover 32, the fan cover 32 is sectioned in the vehicle vertical direction by the duct member 90, and the duct 24 is formed by the bottom wall 84 of the fan cover 32 and the duct member 90. A communication hole 90A is formed in the duct member 90. As shown in FIG. 1, air, that is taken-in from the intake port 18A due to the fan 16, passes through this communication hole 90A and is blown toward a duct 66 side that is disposed at the upper portion of the fan cover 32.

As shown in FIG. 5, in the state in which the fan cover 32 is mounted to the roof head lining 34, the bottom wall 84 is disposed so as to be apart, by distance C3, from the opening portion 54A that is formed in the lower portion of the shroud 54. This distance C3 is set appropriately in consideration of an amount of air flow that is sucked-in from the opening portion 54A formed in the lower portion of the shroud 54, and the head clearance of the cabin 30, and the like. The above-described fan cover 32 is fixed to the roof head lining 34 via unillustrated clips or the like.

(Operation and Effects of Present Embodiment)

The operation and effects of the present embodiment are described next.

In the present embodiment, as shown in FIG. 1 and FIG. 2, the sunroof 44 is provided at the ceiling portion 12 at the upper side of the first row seats 38, and the accommodating portion 48 in which this sunroof 44 is accommodated is provided at the upper side of the area between the first row seats 38 and the second row seat 40. This accommodating portion 48 bulges-out toward the cabin 30 side, and accompanying this, the bulging portion 50 is provided at the roof head lining 34.

Namely, the surface at which the bulging portion 50 is not provided (the reference surface 34B of the roof head lining 34) is positioned further toward the upper side in the vehicle vertical direction than the bottom surface 50A of the bulging portion 50. Therefore, by placing the fan 16 at the rear side of the bulging portion 50, the amount of bulging of the roof head lining 34 into the cabin 30 that arises due to placement of the fan 16 can be avoided.

To describe more concretely, the step portion 52 is provided at the rear side in the vehicle front-rear direction of the bulging portion 50, between the bulging portion 50 and the reference surface 34B of the roof head lining 34, and the fan 16 is disposed at this step portion 52. Therefore, as compared with a case in which a fan is mounted to the bottom surface of the bulging portion although such a case is not illustrated, the amount of bulging of the bulging portion 50 into the cabin 30, that arises due to placement of the fan 16, can be avoided. Due thereto, a reduction in the space at the cabin 30 can be suppressed.

Here, the flow of air at the air conditioning device 10 will be described. As shown in FIG. 1, airflow is generated due to the motor 14 operating and the fan 16 rotating. Namely, air within the cabin 30 is taken-in from the intake port 18A that is formed in the rear end portion of the fan cover 32. Next, the air, that has been taken-in from the intake port 18A, flows within the duct 24, and passes through the communication hole 90A that is formed in the duct member 90, and is introduced into the axially central portion of the fan 16 from the opening portion 54A that is formed in the lower portion of the shroud 54. Next, as shown in FIG. 4, the air, that has been introduced into the axially central portion of the fan 16, is forked-off from the duct 66 toward the first duct portion 66A and the second duct portion 66B, and thereafter, flows into the blow-out portions 20, 22, respectively.

Usually, the positions of the blow-out portions 20, 22 are determined in accordance with the seat positions. In the present embodiment, the fan 16 is disposed at the step portion 52 that is provided between the bottom surface 50A of the bulging portion 50 and the reference surface 34B of the roof head lining 34, and the intake port 18A is formed at the rear end portion of the fan cover 32. Further, the blow-out portions 20, 22 are provided at the front portion of the fan cover 32. Due thereto, the air that is taken into the air conditioning device 10 can be made to flow in one direction from the rear side toward the front side.

Further, in the present embodiment, the blow-out portion 22 (and the same holds for the blow-out portion 20) is structured to include the blow-out port 76 for main flow, that is positioned at the front portion of the blow-out portion 22 and is provided along the vehicle transverse direction, and the blow-out port 78 for air direction adjusting flow, that is formed so as to face the blow-out port 76 for main flow in the vehicle front-rear direction and is provided at the rear portion of the blow-out portion 22.

Moreover, as shown in FIG. 4, a portion of the air, that has flowed into the first flow path 64A of the blow-out portion 22, flows along the guide ribs 80, 82, and thereafter, is blown out from the blow-out port 76 for main flow. As shown in FIG. 6, the airflow F1 that is blown out from the blow-out port 76 flows toward the rear side along the lower wall portion 74A of the lower structural body 74.

At this time, the so-called Coanda effect, in which air at a lower side from this airflow F1 is drawn-in by the airflow F1, can be obtained (hereinafter, the airflow of this air that is drawn-in is called “airflow F2”). Namely, due to the drawing-in phenomenon that is due to the Coanda effect, air at the surroundings is drawn-in and the amount of flow can be increased. As a result, airflow that is in excess of the amount of flow that has been blown out from the blow-out port 76 flows toward the rear (airflow of an amount in which airflow F2 are added to airflow F1).

In the present embodiment, the blow-out port 76 for main flow and the blow-out port 78 for air direction adjusting flow are provided so as to oppose each other in the vehicle front-rear direction. By utilizing the airflows that are blown out from the blow-out port 76 and the blow-out port 78, as shown in FIG. 2, air can be blown respectively toward passengers P1, P2 who are seated in the second row seat 32 and the third row seat 42.

Concretely, in the state in which the damper 70 shown in FIG. 4 is fully open, another portion of the air, that has flowed-in into the first flow path 64A of the blow-out portion 22, flows through the second flow path 64B into the third flow path 64C. In this way, the air, that has flowed into the third flow path 64C of the blow-out portion 22, flows along the guide ribs 80, 82, and thereafter, is blown out from the blow-out port 78.

As shown in FIG. 6, the airflow F3 from this blow-out port 78 is blown out toward the lower side. Thereupon, the airflow F3 from the blow-out port 78 merges, from an intersecting direction, with the airflow F1 from the blow-out port 76 and the airflow F2 that is introduced by this airflow F1.

As a result, the air directions of the airflow F1 blown out from the blow-out port 76, and the airflow F2, are changed (hereinafter, the airflow whose air direction has been changed is called “airflow F4”). Namely, at the time when the damper 70 is set in the fully open state, the airflow F4 is generated entirely toward the passengers P1 (refer to FIG. 2) who are seated in the second row seat 32.

Further, in the state in which the damper 70 shown in FIG. 4 is fully closed, it is difficult for the airflow, that has flowed into the first flow path 64A, to flow through the second flow path 64B into the third flow path 64C. Therefore, the amount of flow of the airflow F1, that is blown out from the blow-out port 76, increases, and, conversely, the amount of flow of the airflow F3 that is blown out from the blow-out port 78 decreases.

As a result, the airflow F1 and the airflow F2 are not affected that much by the airflow F3, and flow toward the vehicle rear side. Accordingly, an airflow F4′ flows entirely toward the passengers P2 (refer to FIG. 2) who are seated in the third row seat 34.

### Modified Examples of Present Embodiment

(1) In the above-described present embodiment, as shown in FIG. 1, description is given of an example in which the intake port 18A of air is provided at the rear end portion of the fan cover 32, but the position of the intake port 18A is not limited to this.

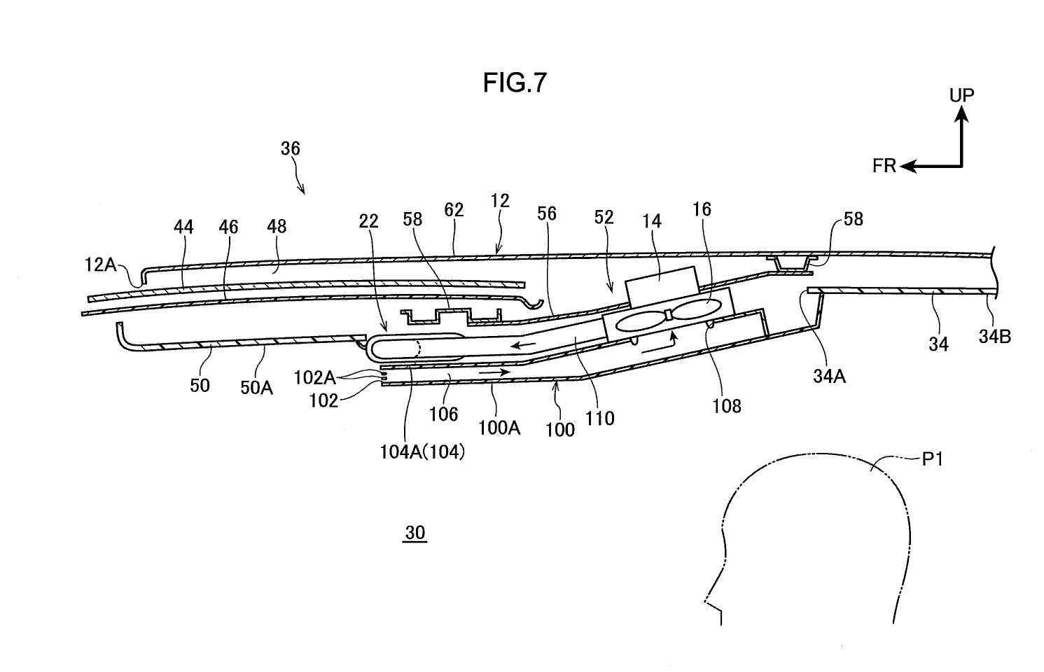

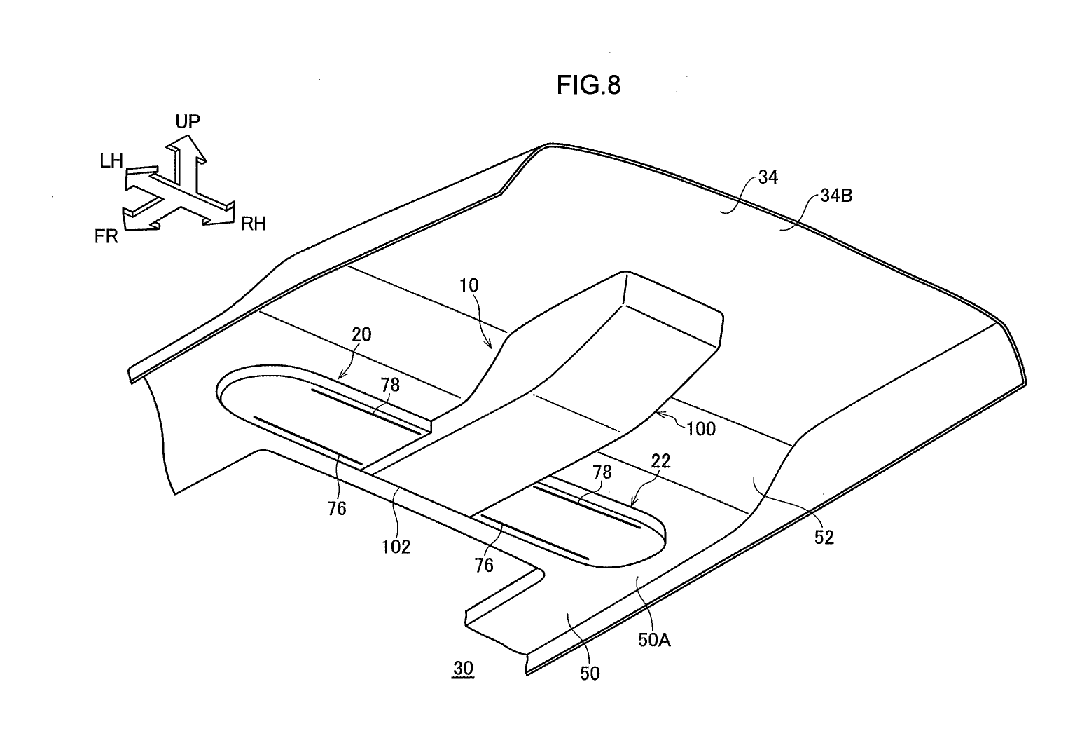

For example, as shown in FIG. 7 and FIG. 8, an intake port 102 of air may be provided at a front end portion of a fan cover 100. Here, in the state in which the fan 16 is disposed at the step portion 52 of the roof head lining 34 as shown in FIG. 1, in the event that an intake port 102 is disposed at a front side of the fan 16 as shown in FIG. 7, it may be necessary to cause the airflow (shown by the arrows in FIG. 7) to move reciprocally along the vehicle front-rear direction.

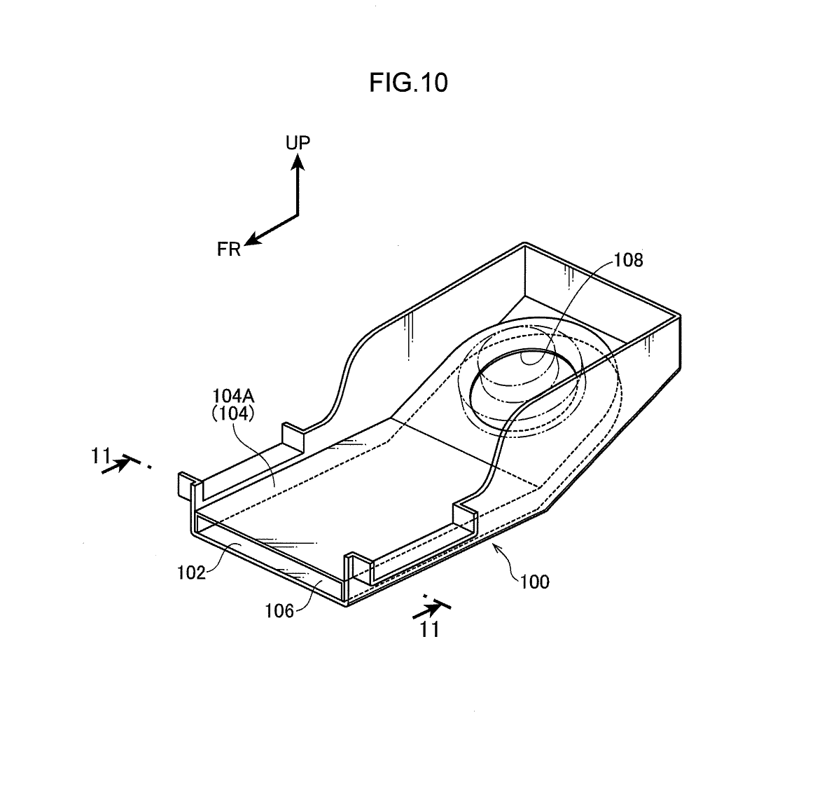

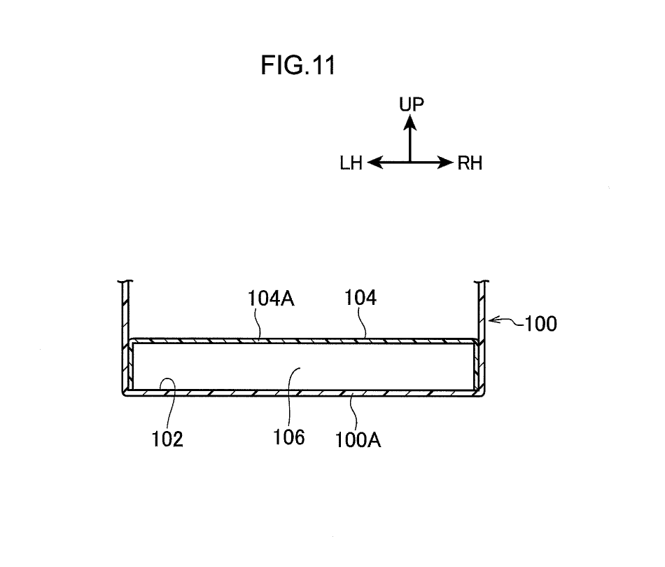

In this case, for example, the fan cover 100 is structured in two vertical levels at the front side as well, as shown in FIG. 10 and FIG. 11. Concretely, a duct member 104, that opens toward the lower side and that is formed in an upside-down U shape in cross section as seen from the vehicle front, is provided at the lower portion of the fan cover 100. Due to this duct member 104 being fit-together with the lower portion of the fan cover 100, the lower portion of the fan cover 100 is sectioned in the vehicle vertical direction by an upper wall 104A of this duct member 104. A duct 106 is formed by this duct member 104 and a bottom wall 100A of the fan cover 100. The intake port 102, that is structured by plural rectangular holes 102A (see FIG. 7) that are formed along the vehicle transverse direction, is provided at a front end portion of this duct 106.

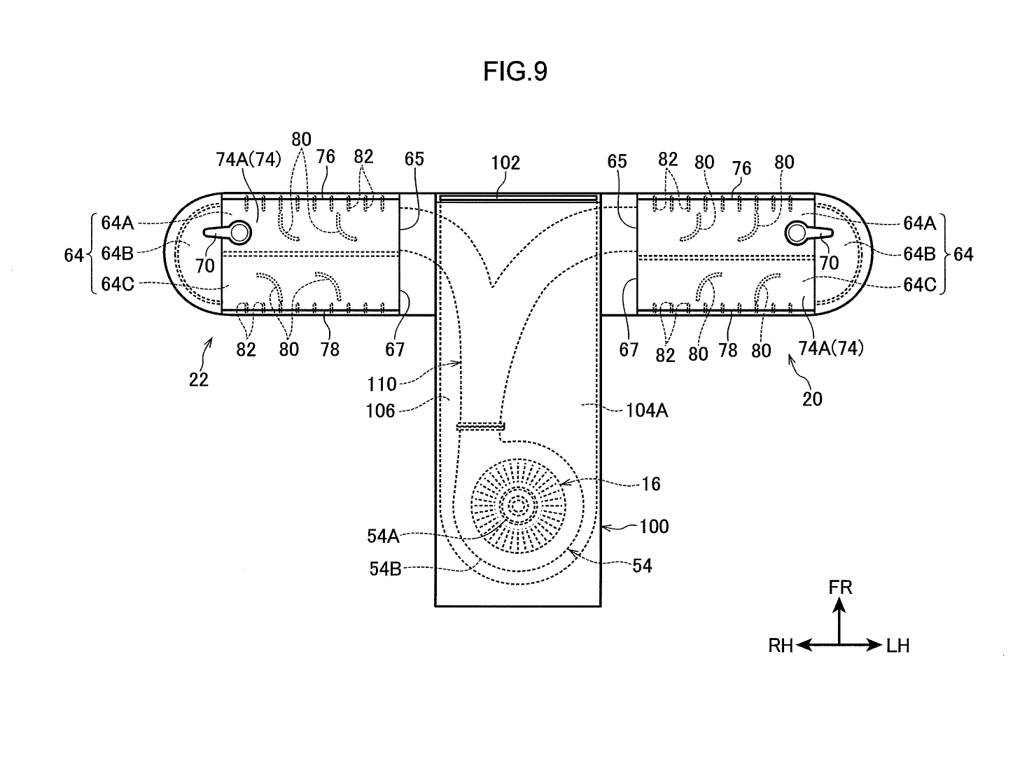

On the other hand, at the upper portion of the fan cover 100, a duct 110 that is described later can be placed on an upper wall 104A of the duct member 104. A communication hole 108 is formed in the upper wall 104A of the duct member 104. As shown in FIG. 7, the air, that is taken-in by the fan 16 from the intake port 102 and flows through the duct 106 interior, is blown through this communication hole 108 toward the duct 110 side that is disposed at the upper portion of the fan cover 100. As shown in FIG. 9, the blow-out portions 20, 22 are respectively connected to the duct 110, and therefore, air is blown out through these blow-out portions 20, 22 to the cabin 30 (see FIG. 7).

In the present embodiment, as shown in FIG. 7, the intake port 102 of air is formed in the front end portion of the fan cover 100. Generally, a register (not illustrated) is provided at an instrument panel 112 (see FIG. 2) that structures the front portion of the cabin 30, and air, whose temperature has been adjusted by an air conditioning device, is blown out from this register. Therefore, by forming the intake port 102 at the front end portion in the vehicle front-rear direction of the fan cover 100, the air that has been blown out from the register can be taken-in from the intake portion. Due thereto, the air within the cabin 30 can be adjusted efficiently.

Note that, here, in order to describe the flow of the airflow that is shown by the arrows, description is given of a case in which the duct 110 and the duct 106 are disposed so as to be superposed vertically. However, it is also possible to make it such that the duct 110 and the duct 106 are not superposed vertically. Due thereto, the fan cover 100 can be made to be thin.

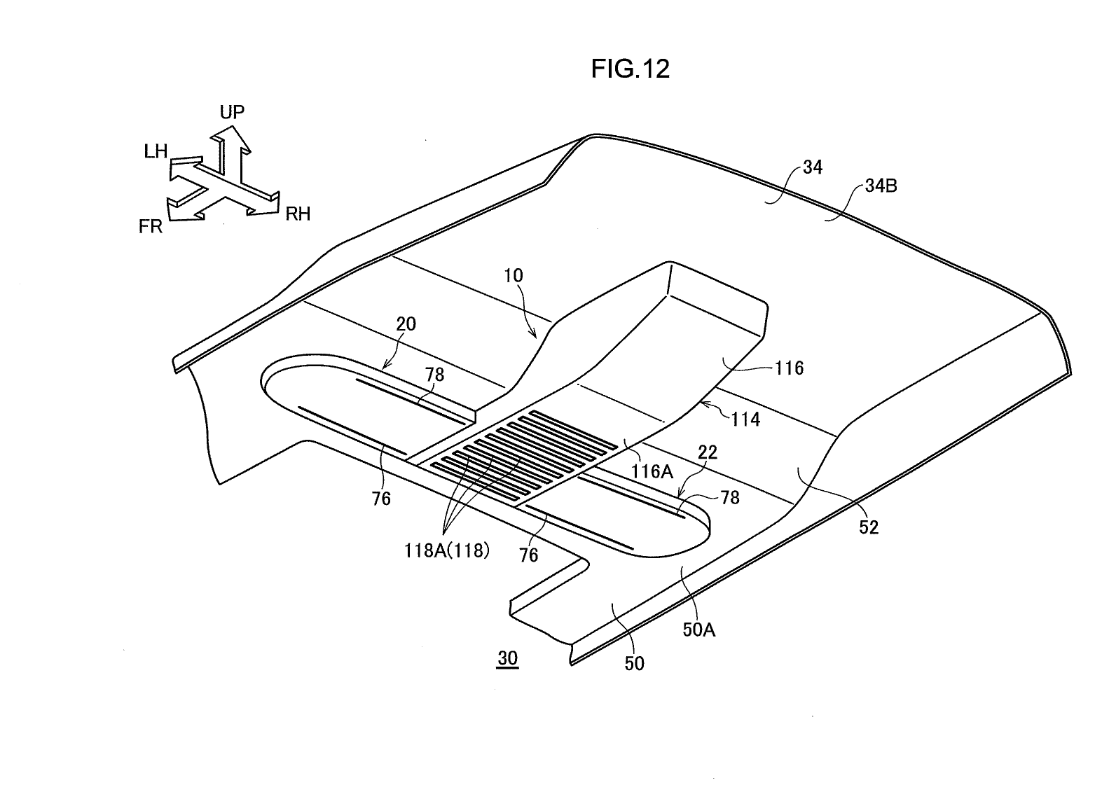

(2) In the above-described embodiment, description is given of an example in which the intake port 102 is provided at the front end portion in the vehicle front-rear direction of the fan cover 100. However, other than this, as shown in FIG. 12, an intake port 118, that is structured by plural rectangular holes 118A that are formed along the vehicle transverse direction, may be provided in a horizontal portion 116A that structures a bottom wall 116 of a fan cover 114.

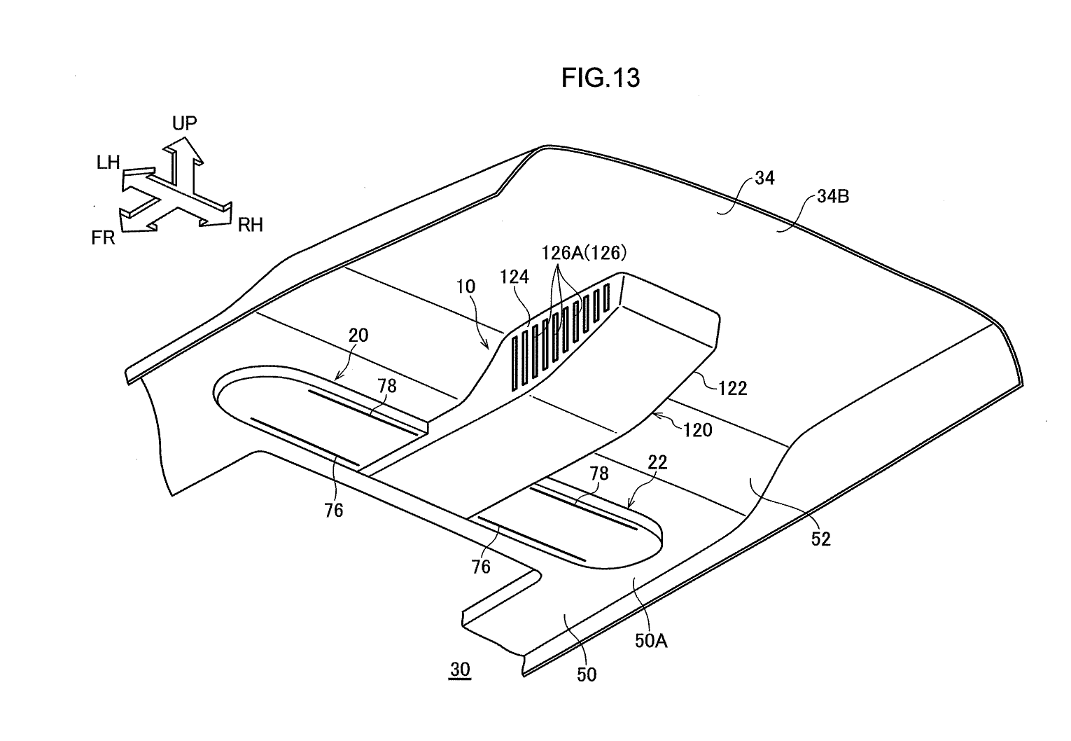

(3) Further, as shown in FIG. 13, intake ports 126, that are structured by plural rectangular holes 126A that are formed along the vehicle vertical direction, may be provided in a right-side wall 122 and a left-side wall 124 that structure a fan cover 120.

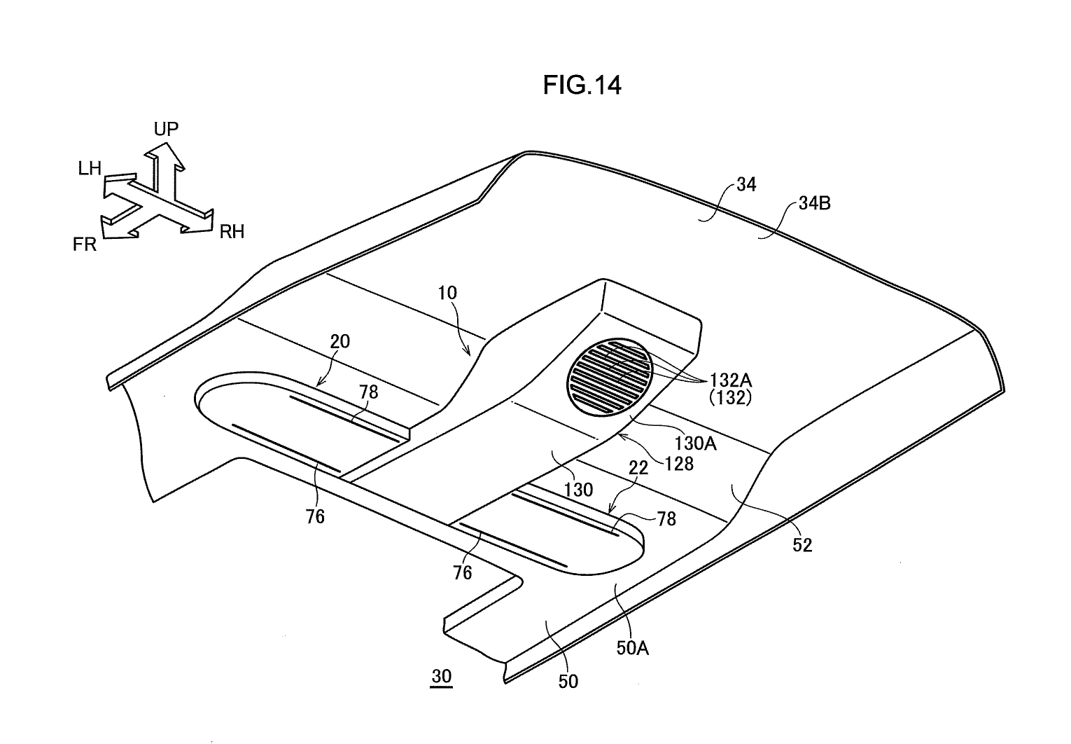

(4) Moreover, as shown in FIG. 14, an intake port 132, that is structured by plural rectangular holes 132A that are formed along the vehicle transverse direction, may be provided in an inclined portion 130A that structures a bottom wall 130 of a fan cover 128.

In this way, the intake port may be provided anywhere, and the shape and the like thereof are not particularly limited. Further, in the above-described embodiments, the intake port is structured by plural rectangular holes, but these rectangular holes may be formed in a state of being inclined with respect to a horizontal surface so that it is easy to take-in the air within the cabin.

Further, in the above-described embodiment, as shown in FIG. 2, description is given of an example in which the one-box vehicle having three rows of seats is used as the vehicle 36 that is provided with the air conditioning device 10. However, it suffices that any vehicles are appropriate in which the accommodating portion 48 of the sunroof 44 is provided at the cabin side 30, and the vehicle may, of course, be a sedan-type vehicle having two rows of seats.

Embodiments of the present invention have been described above, but the present invention is not limited to the above description, and can be implemented by being modified in various ways other than those described above, within a scope that does not deviate from the gist thereof.

Japanese Patent Application No. 2012-158918 is incorporated herein by reference. All publications, patent applications, and technical standards mentioned in this specification are herein incorporated by reference to the same extent as if each individual publication, patent application, or technical standard was specifically and individually indicated to be incorporated by reference.

1. An air conditioning device for a vehicle, comprising:
an intake portion that is provided at a cabin side at a vehicle ceiling portion, and that takes-in air;
a blow-out portion that is provided at the cabin side at the vehicle ceiling portion, and that blows out, into the cabin, air that has been taken-in from the intake portion; and
a blower device that is provided at the vehicle ceiling portion and that, by operating, blows air from the intake portion toward the blow-out portion, the blower device being disposed at a vehicle front-rear direction rear side of a bulging portion that bulges toward the cabin side and that accommodates a sunroof that opens and closes a roof opening portion that is formed in the vehicle ceiling portion,
wherein, the blow-out portion is provided along a vehicle transverse direction, and is structured to comprise:
a first blow-out port that is positioned at a vehicle front-rear direction front portion and is provided along the vehicle transverse direction; and
a second blow-out port that is provided at a vehicle front-rear direction rear portion with respect to the first blow-out port.

2. The air conditioning device for a vehicle of claim 1, wherein the blower device is provided at a step portion that is provided between the bulging portion, that is provided at a roof head lining that structures a portion of the vehicle ceiling portion, and a reference surface of the roof head lining, that is positioned further toward a vehicle vertical direction upper side than a bottom surface of the bulging portion.

3. The air conditioning device for a vehicle of claim 1, wherein the intake portion is disposed at a vehicle front-rear direction rear side with respect to the blow-out portion.

4. The air conditioning device for a vehicle of claim 1, wherein the intake portion is disposed at a vehicle front-rear direction front side with respect to the blow-out portion.

5. (canceled)

6. The air conditioning device for a vehicle of claim 1, wherein air, that has been blown out from the first blow-out port, is set so as to flow along a surface of the blow-out portion toward a second blow-out port side.

7. The air conditioning device for a vehicle of claim 6, wherein the second blow-out port is set so as to blow out air toward the cabin, such that the air intersects the air that has been blown out from the first blow-out port.
